(19) United States
(12) Patent Application Publication
(10) Pub. No.: US 2026/0083244 A1
(43) Pub. Date: Mar. 26, 2026

(54) MASSAGE MACHINE FRAME, MASSAGE MACHINE AND CONTROL METHOD THEREOF

(71) Applicant: FUJI Medical Instruments MFG. CO.,LTD., Osaka-shi (JP)

(72) Inventors: Meiman LIN, Xiamen (CN); Jiafu CHEN, Xiamen (CN); Zhiming CHEN, Xiamen (CN)

(21) Appl. No.: 19/333,870

(22) Filed: Sep. 19, 2025

(30) Foreign Application Priority Data
Sep. 23, 2024 (CN) 202411328255.0
Jul. 18, 2025 (CN) 202511001211.1

(51) Int. Cl. A47C 1/034; A47C 1/032; A47C 3/025; A61H 37/00

(52) U.S. Cl. CPC A47C 1/0347; A47C 1/03211; A61H 37/00; A47C 3/0251; A61H 2201/0149; A61H 2201/0192; A61H 2201/1623; A61H 2201/164; A61H 2201/1664; A61H 2201/1671; A61H 2201/1676; A61H 2203/0431; A61H 2203/0487

(57) ABSTRACT

The massage machine frame of the present invention comprises a base and a seating unit which is supported to the base in such a way that the seating unit is movable relative to the base, wherein one of the base and the seating unit has a guide rail and the other has a mating portion cooperating with the guide rail, the guide rail including: a first guide rail in the shape of a circular arc projecting forward; and a second guide rail in the shape of a circular arc projecting rearward and having a different center of circle than the first guide rail, the mating portion including: a first mating portion switchable from moving on the first guide rail to moving on the second guide rail; and a second mating portion which moves on the second guide rail.

### INCORPORATION BY REFERENCE

This application is based on and claims the benefit of priority from Chinese Patent Application No. 202411328255.0 filed on Sep. 23, 2024 and Chinese Patent Application No. 202511001211.1 filed on Jul. 18, 2025, the contents of which are hereby incorporated by reference.

### TECHNICAL FIELD

The present disclosure relates to a massage machine frame, a massage machine and a control method of the massage machine.

### BACKGROUND

In the patent document CN 213157432 U, disclosed is a massage chair including a seat frame and a backrest iron frame, where a first chute frame and a second chute frame are fixed over the seat frame, and a roller slidably connected to the first chute frame and a roller slidably connected to the second chute frame are provided on the backrest iron frame via a roller bracket, which allows the backrest iron frame to swing back and forth relative to the seat frame.

In the massage chair described above, by sliding the roller, which is slidably connected to the first chute frame, to the frontmost position, a backrest of the backrest iron frame can recline backward to the maximum extent, whereby a zero gravity mode is possible.

However, in the massage chair described above, even if the roller slidably connected to the first chute frame slides to the rearmost position and the backrest of the backrest iron frame is raised forward to its fully upright position, the backrest of the backrest iron frame still reclines backward to a certain extent, and a seating unit of the backrest iron frame is in a state where a front end is higher than a rear end, so that a subject is not easy to get up.

### SUMMARY

The present disclosure has been accomplished in view of the above problems, with the aim of providing a massage machine frame, a massage machine and a control method thereof, where the massage machine frame easily realizes a zero gravity mode and an assisted-standing mode in a compact structure.

In order to achieve the above objective, the present disclosure provides a massage machine frame including a base and a seating unit which is supported to the base in such a way that the seating unit is movable relative to the base, where one of the base and the seating unit has a guide rail and the other has a mating portion cooperating with the guide rail, the guide rail including: a first guide rail in the shape of a circular arc projecting forward; and a second guide rail in the shape of a circular arc projecting rearward and having a different center of circle than the first guide rail, the mating portion including: a first mating portion switchable from moving on the first guide rail to moving on the second guide rail; and a second mating portion which moves on the second guide rail.

According to the massage machine frame of the present disclosure, the first guide rail is circular arc-shaped with a forward convex curvature, and thus, by moving the first mating portion on the first guide rail, the seating unit is easily caused to recline substantially rearward, forming the zero gravity mode; and the second guide rail is circular arc-shaped with a rearward convex curvature and has a different center than the first guide rail, and thus, by switching the first mating portion to move on the second guide rail, the rear end of the seating unit is easily raised substantially, thereby forming the assisted-standing mode to facilitate the subject's standing up. Moreover, by forming the first guide rail and the second guide rail into a circular arc, in contrast to the case where the first guide rail and the second guide rail extend in a straight line, the overall machine frame may be more compact in the front-rear direction. With this compact structure, the seating drive device requires only a small stroke of telescopic movement to enable the front and rear ends of the seating unit to have a large mutual positional relationship change in the vertical direction.

Furthermore, in the massage machine frame of the present disclosure, a lower end of the first guide rail and a lower end of the second guide rail are connected to each other.

According to the present disclosure, by connecting the lower end of the first guide rail and the lower end of the second guide rail to each other, the first mating portion may enter the second guide rail from the point of connection of the lower end of the guide rail, and both the first mating portion and the second mating portion may move along the second guide rail. When both the first mating portion and the second mating portion move along the second guide rail, the seating drive device requires only a small stroke of telescopic movement to push the seating unit such that same has a large movement travel in the vertical direction. In contrast to the case where the lower end of one of the first and second guide rails is located halfway of the other guide rail in the vertical direction, it is easy to make the overall machine frame compact in the vertical direction. This makes it easy to switch to the assisted-standing mode.

In addition, in the massage machine frame of the present disclosure, the first guide rail has a radius smaller than that of the second guide rail.

According to the present disclosure, by setting the radius of the first guide rail to be smaller than the radius of the second guide rail, it is easy to cause the seating unit to quickly and substantially recline rearward to form the zero gravity mode when the first mating portion moves on the first guide rail.

In addition, in the massage machine frame of the present disclosure, a leg support is also included, where the leg support is rotatably supported to the seating unit via a rotating shaft, and the distance between the center of the first mating portion and the axis of the rotating shaft is equal to the distance between the center of the second mating portion and the axis of the rotating shaft.

Furthermore, in the massage machine frame of the present disclosure, the distance between the center of the first mating portion and the center of the second mating portion is equal to the radius of the first guide rail.

Furthermore, in the massage machine frame of the present disclosure, an upper end of the first guide rail is lower than an upper end of the second guide rail.

In accordance with the present disclosure, when the second mating portion is located to a maximum extent away from the first guide rail, it is easy to make the rear end of the seating unit higher than the front end of the seating unit, and it is easier for the subject to stand up.

Furthermore, in the massage machine frame of the present disclosure, the first mating portion and the second mating portion are rollers.

Furthermore, in the massage machine frame of the present disclosure, a backrest is also included, where the backrest is rotatably connected to the seating unit, or alternatively, the backrest and the seating unit are fixedly formed as a whole.

According to the present disclosure, in the case where the backrest is fixed to the seating unit to form an integrated seat frame, a backrest drive device may be omitted, and various modes such as the zero gravity mode and the assisted-standing mode are realized by a single drive device (the seating drive device), thereby reducing production costs.

Furthermore, in the massage machine frame of the present disclosure, also included is a seating drive device, which includes: a seating drive push rod rotatably connected to one of the base and the seating unit; and a seating drive slider movable along the seating drive push rod and rotatably connected to the other of the base and the seating unit.

Furthermore, in order to achieve the above objective, the present disclosure provides a massage machine, including a massage machine frame according to any one of the above.

In order to achieve the above objective, the present disclosure provides a control method of a massage machine for controlling the aforementioned massage machine, where the massage machine performs at least one of a zero gravity mode and an assisted-standing mode; in the zero gravity mode, the first mating portion slides on the first guide rail, and the second mating portion slides on the second guide rail; and in the assisted-standing mode, the first mating portion and the second mating portion are located on the second guide rail, and the second mating portion is located to a maximum extent away from the first guide rail.

According to the massage machine frame of the present disclosure, the first guide rail is in the shape of a circular arc which projects forward, and thus, by moving the first mating portion on the first guide rail, the seating unit is easily caused to recline substantially rearward, forming the zero gravity mode; also, the second guide rail is in the shape of a circular arc which projects rearward and has a different center than the first guide rail, and thus, by switching the first mating portion to move on the second guide rail, the rear end of the seating unit is easily raised substantially, thereby forming the assisted-standing mode to facilitate the subject's standing up; moreover, by forming the first guide rail and the second guide rail into a circular arc, in contrast to the case where the first guide rail and the second guide rail extend in a straight line, the overall machine frame may be more compact in the front-rear direction. With this compact structure, the seating drive device requires only a small stroke of telescopic movement to enable the front and rear ends of the seating unit to have a large mutual positional relationship change in the vertical direction.

### BRIEF DESCRIPTION OF THE DRAWINGS

FIG. 1 is a perspective view schematically showing a state of a massage machine frame in a standby mode according to an implementation of the present disclosure, and showing the situation as viewed from the rear.

FIG. 2 is an exploded view schematically showing a massage machine frame according to an implementation of the present disclosure.

FIG. 3 is a perspective view schematically showing a partial structure of a massage machine frame according to an implementation of the present disclosure.

FIG. 4 is a perspective view schematically showing a state of a massage machine frame in a zero gravity mode according to an implementation of the present disclosure, and showing the situation as viewed from the rear.

FIG. 5 is a perspective view schematically showing a state of a massage machine frame in an assisted-standing mode according to an implementation of the present disclosure, and showing the situation as viewed from the rear.

FIG. 6 is a perspective view schematically showing a state of a massage machine frame in a standby mode according to a variant embodiment of the present disclosure, and showing the situation as viewed from the front.

FIG. 7 is an exploded view schematically showing a massage machine frame according to a variant embodiment of the present disclosure.

FIG. 8 is a side view schematically showing a state of a massage machine frame in a standby mode according to a variant embodiment of the present disclosure.

FIG. 9 is a side view schematically showing a state of a massage machine frame in a zero gravity mode according to a variant embodiment of the present disclosure.

FIG. 10 is a side view schematically showing a state of a massage machine frame in an assisted-standing mode according to a variant embodiment of the present disclosure.

### DETAILED DESCRIPTION OF EMBODIMENTS

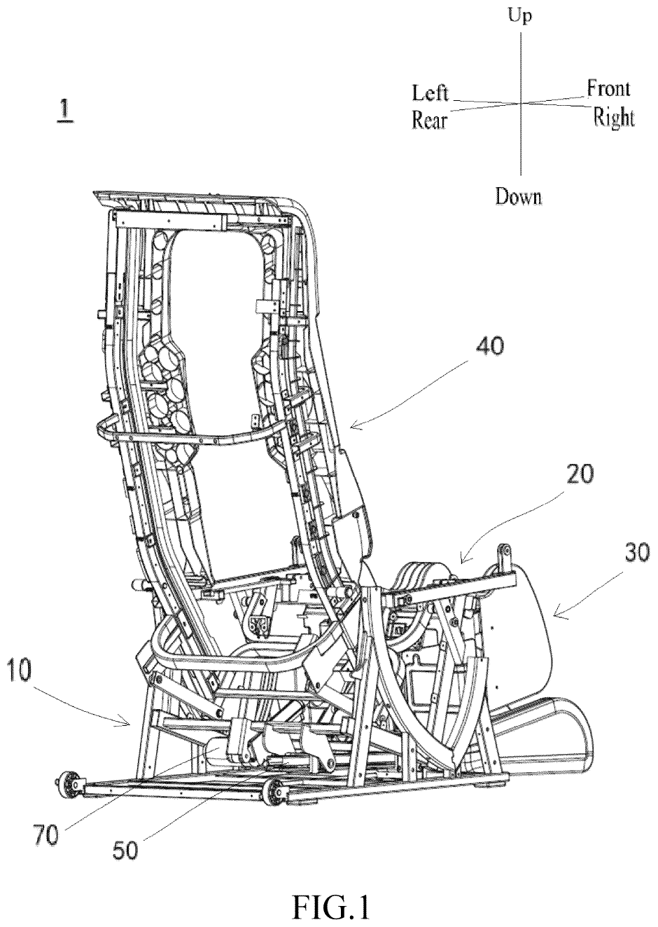

A massage machine frame according to an implementation of the present disclosure will be described below with reference to FIGS. 1 to 5 and by means of taking a chair frame of a massage chair as an example. However, the massage machine frame is not limited to the massage chair, but can also be used for other massage machines such as a massage bed.

Here, for convenience of illustration, an orientation of the structure of the massage machine is described based on a perspective of a subject sitting on the massage machine. For example, the front side (front side), which is viewed by the subject sitting on the massage machine, is referred to as the “front side” or “the front”, the rear side (back side) thereof is referred to as the “rear side” or “the rear”, the upper side (head side) thereof is referred to as the “upper side” or “above”, the lower side (foot side) is referred to as “lower side” or “below”, the right side is referred to as “right side” or “the right”, and the left side is referred to as “left side” or “the left”. In addition, a shoulder width direction of the subject sitting on the massage machine is simply referred to as the “shoulder width direction”, that is, the left-right direction of the massage machine. The “outer side in the shoulder width direction” corresponds to the direction away from the neck of the subject in the shoulder width direction, and the “inner side in the shoulder width direction” corresponds to the direction near the neck of the subject in the shoulder width direction.

### (Overall Structure of Massage Machine Frame)

As shown in FIGS. 1 to 3, a massage machine frame 1 includes a base 10 and a seating unit 20. The seating unit 20 is supported to the base 10 in such a way that the seating unit is movable relative to the base 10. Guide rails 12 are arranged on left and right sides of the base 10, and mating portions 24 which cooperate with the guide rails 12 are arranged on left and right sides of the seating unit 20. The guide rails 12 include a first guide rail 121 and a second guide rail 122. The first guide rail 121 is in the shape of a circular arc projecting forward. The second guide rail 122 is in the shape of a circular arc projecting rearward and having a different center than the first guide rail 121. The mating portion 24 includes a first mating portion 241 and a second mating portion 242. The first mating portion 241 is capable of switching from moving on the first guide rail 121 to moving on the second guide rail 122. The second mating portion 242 moves on the second guide rail 122.

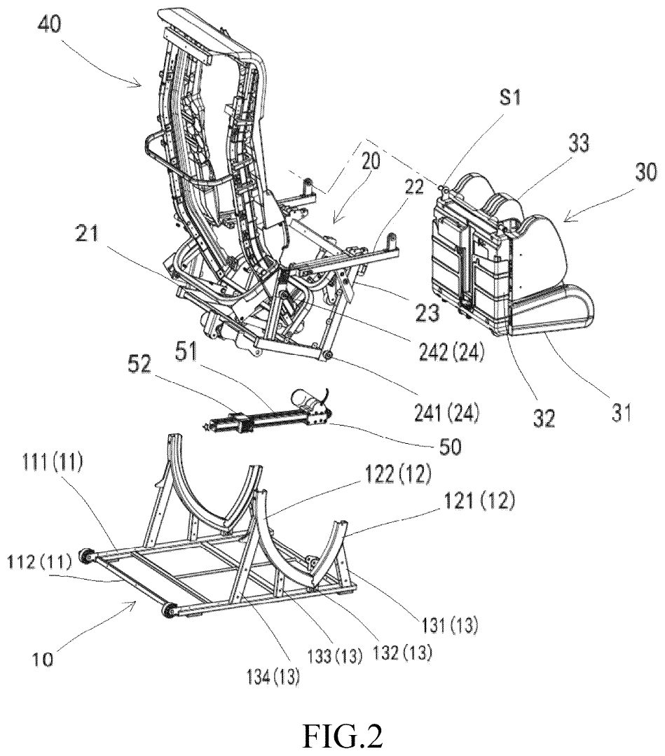

Here, as shown in FIGS. 1 and 2, the massage machine frame 1 also includes a leg support 30 and a backrest 40. The leg support 30 is rotatably supported to the seating unit 20 via a first rotating shaft S1. The backrest 40 is rotatably supported to the seating unit 20 via a second rotating shaft (not shown).

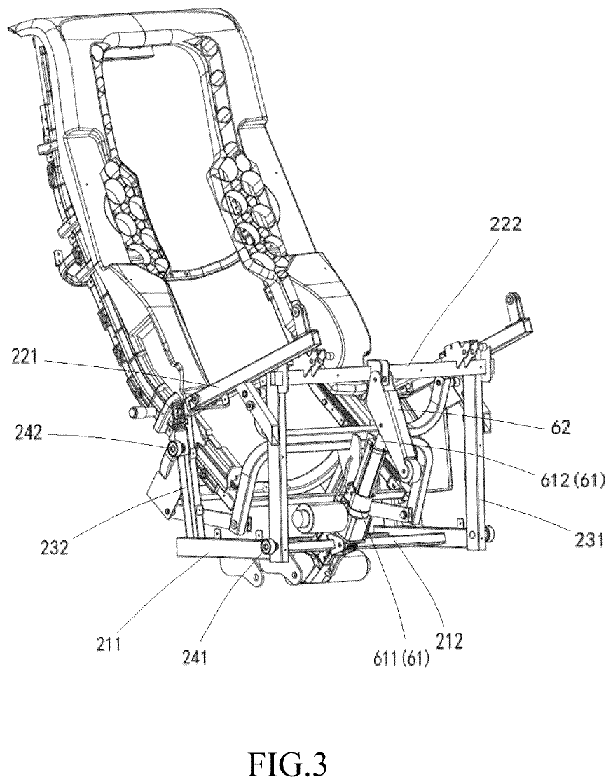

In addition, as shown in FIG. 2, the massage machine frame 1 also includes a seating drive device 50. The seating drive device 50 drives the seating unit 20 to rotate relative to the base 10. As described later, during movement of the seating unit 20 along the guide rails 12, changes are made in front-rear and up-down directions relative to the base 10, thereby rotating relative to the base 10. Furthermore, as shown in FIGS. 1 and 3, the massage machine frame 1 further includes a leg support drive device 60 and a backrest drive device 70. The leg support drive device 60 drives the leg support 30 to rotate about the first rotating shaft S1 relative to the seating unit 20, thereby changing an angle of the leg support 30 relative to the seating unit 20. The backrest drive device 70 drives the backrest 40 to rotate about a second rotating shaft relative to the seating unit 20, thereby changing an angle of the backrest 40 relative to the seating unit 20.

In addition, although not illustrated, it is also possible to provide a control portion on the massage machine frame 1, which control portion is adapted to control actions of the seating drive device 50, the leg support drive device 60 and the backrest drive device 70. Moreover, a storage component for storing control commands can also be provided on the massage machine frame 1.

### (Base)

As shown in FIGS. 1 and 2, the base 10 is a support frame that supports functional components, including the leg support 30, the seating unit 20 and the backrest 40 as a whole.

Here, although not illustrated, a base cover (which may be made of plastic, etc.) covering the base 10 is usually provided in practice.

In addition, as shown in FIGS. 1 and 2, the base 10 includes guide rails 12 which guide a movement trajectory of the seating unit 20.

Specifically, as shown in FIG. 2, the base 10 includes a bottom 11, the guide rails 12 and a connecting portion 13. A bottom surface of the bottom 11 is in contact with a supporting surface such as the ground, and a plane in which the bottom 11 is located can also be considered as the bottom surface. The guide rails 12 are located above the bottom 11 and are connected to the bottom 11 via the connecting portion 13. Front and rear ends of the guide rail 12 each are higher than the bottom 11.

More specifically, as shown in FIG. 2, the bottom 11 is configured as a support base of the support frame, the support base including: a pair of first cross bars 111 extending in a front-rear direction and spaced apart in a left-right direction; and a plurality of second cross bars 112 extending in the left-right direction, arranged at spaced intervals in the front-rear direction, and connecting the pair of first cross bars 111 to each other.

The guide rails 12 extend in the front-rear direction, and a pair of guide rails are provided in the left-right direction at a spaced interval. The pair of guide rails 12 include a first guide rail 121 and a second guide rail 122, respectively. The first guide rail 121 is in the form of a circular arc projecting forward (in the illustrated example, projecting in a forward-downward direction). The second guide rail 122 is in the form of a circular arc projecting rearward (in the illustrated example, projecting in a rearward-downward direction). The first guide rail 121 has a radius different from that of the second guide rail 122. A lower end of the first guide rail 121 and a lower end of the second guide rail 122 are connected to each other (the lower end of the first guide rail 121 and the lower end of the second guide rail 122 may be joined using either a rounded connection or an angular connection), so that the first mating portion 241 described later can slidably move from the first guide rail 121 to the second guide rail 122, or from the second guide rail 122 to the first guide rail 121. An upper end of the first guide rail 121 is lower than an upper end of the second guide rail 122.

That is, in this implementation, the first guide rail 121 and the second guide rail 122 are connected in a way that the rails of the two are mutually continuous. The first guide rail 121 extends forward from the point of connection. The second guide rail 122 extends rearward from the point of connection. The first guide rail 121 is a circular arc-shaped guide rail having a defined center and a defined radius. The second guide rail 122 is also a circular arc-shaped guide rail having a defined center and a defined radius. The first guide rail 121 has a radius smaller than that of the second guide rail 122. The first guide rail 121 has a center different from that of the second guide rail 122. The first guide rail 121 and the second guide rail 122 are arranged opposite each other, with their respective centers located on opposite sides of each other. The first guide rail 121 is located on an inner side of a virtual arc where the second guide rail 122 extends forward from the point of connection along the arc in which it is located.

The connecting portion 13 is connected between the guide rail 12 and the first cross bar 111 on the respective side. The connecting portion 13 includes a pair of first vertical bars 131, a pair of second vertical bars 132, a pair of third vertical bars 133 and a pair of fourth vertical bars 134. The pair of first vertical bars 131 extend obliquely with respect to the vertical direction (which extends obliquely in a manner where an upward direction corresponds to a rearward direction, in the illustrated example), are spaced apart in the left-right direction, and connect the vicinity of the front end of the guide rail 12 (in the illustrated example, near the front end of the first guide rail 121) to the vicinity of the front end of the first cross bar 111. The pair of second vertical bars 132 extend in the vertical direction, are spaced apart in the left-right direction, and connect the length of the guide rail 12 midway (in the illustrated example, the rear end of the first guide rail 121, and the front end of the second guide rail 122) to the length of the first cross bar 111 midway. The pair of third vertical bars 133 extend in the vertical direction, are spaced apart in the left-right direction, and connect the length of the guide rail 12 midway (in the illustrated example, the lengthwise middle of the second guide rail 122) to the first cross bar 111 near a lengthwise center portion. The pair of fourth vertical bars 134 extend obliquely with respect to the vertical direction (which extends obliquely in a manner where an upward direction corresponds to a forward direction, in the illustrated example), are spaced apart in the left-right direction, and connect the vicinity of the rear end of the guide rail 12 (near the rear end of the second guide rail 122 in the illustrated example) to the length of the first cross bar 111 halfway (in the illustrated example, a position about one-third of the length of the first cross bar 111 away from the rear end of the first cross bar 111). The length of the fourth vertical bar 134, the length of the first vertical bar 131, the length of the third vertical bar 133, and the length of the second vertical bar 132 are successively reduced.

### (Seating Unit and Drive Structure Thereof)

As shown in FIGS. 1 to 3, the seating unit 20 is a support frame for supporting the buttocks and thighs of a subject.

Here, although not illustrated, a seating cover covering the seating unit 20 (the portion in contact with the buttocks and thighs of the subject when in use, is for example, made of leather material, fabric, etc.) is usually provided in practice.

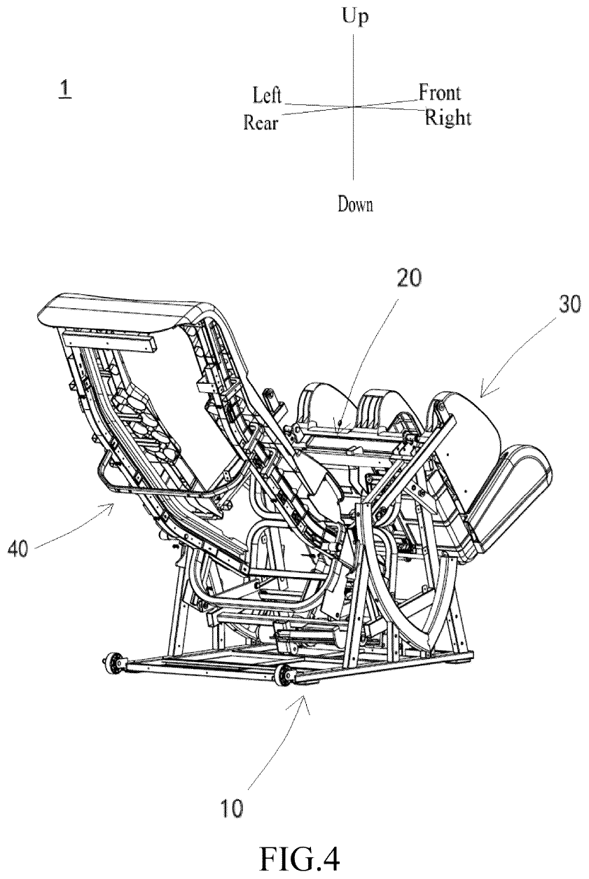

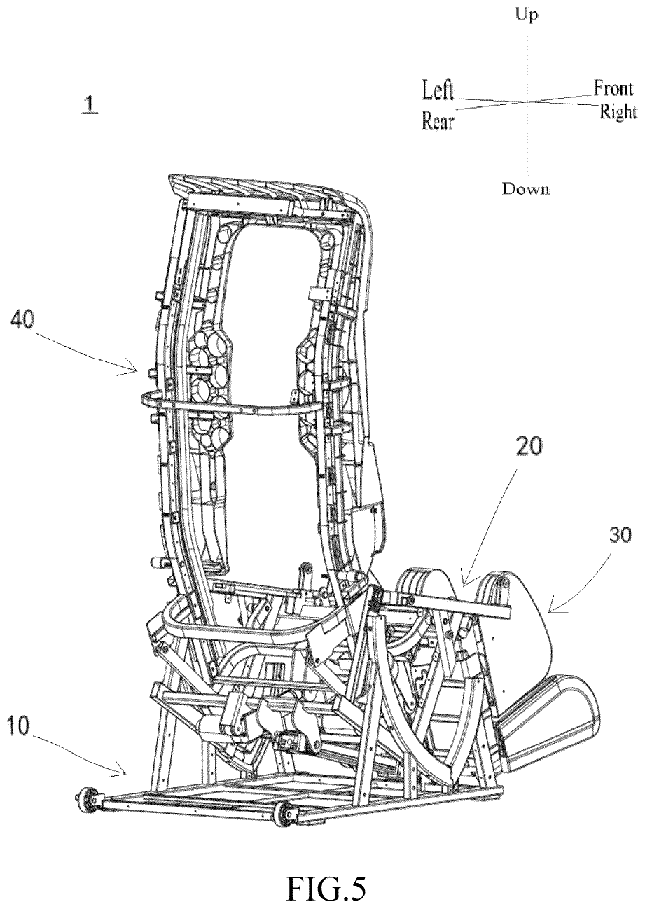

Furthermore, as shown in FIG. 1, the seating unit 20 is carried on the guide rail 12, is slidably connected to the base 10 via the guide rail 12, and rotates relative to the base 10 while sliding relative to the base 10. The seating unit 20 can move along the guide rail 12 to switch between a number of states such as a standby mode, a zero gravity mode, and an assisted-standing mode, etc. In this way, the same seating drive device 50 drives the seating unit 20 to move relative to the guide rail 12, so that the seating unit 20 can switch between a plurality of states including, for example, the zero gravity mode and the assisted-standing mode. During the switching between the plurality of states, the positional relationship between the front end and the rear end of the upper surface of the seating unit 20 with respect to each other can be smoothly changed, so that the seating unit 20 can be formed with other functional components of the massage chair in a state adapted to the respective modes, in which the subject can be kept in the most comfortable condition. For example, in the state of the standby mode, as shown in FIG. 1, the front end of the upper surface of the seating unit 20 (in the illustrated example, which is flush with upper surfaces of top side bars 221 of a seating top 22 as described below, and in the case of providing the seating cover, which corresponds to the portion in contact with the buttocks and thighs of the subject when the seating cover is in use) is slightly higher than or level with the rear end. This allows the subject to be seated and to remain in an initial posture suitable for entering other massage modes. In the zero gravity mode, as shown in FIG. 4, the front end of the upper surface of the seating unit 20 is much higher than the rear end. In the zero gravity mode, not only the backrest 40, the seating unit 20 and the leg support 30 form a prescribed angle with respect to each other in sequence, it is thus possible to maintain the subject in a suitable posture, and by adjusting the angle of the seating unit 20 to the horizontal so that the front end of the upper surface of the seating unit 20 is higher than the rear end, it is also possible to adjust the position of the center of gravity of the subject located in the seating unit 20, thereby providing a more comfortable massage experience for the subject. In the assisted-standing mode, as shown in FIG. 5, the front end of the upper surface of the seating unit 20 is slightly lower than the rear end.

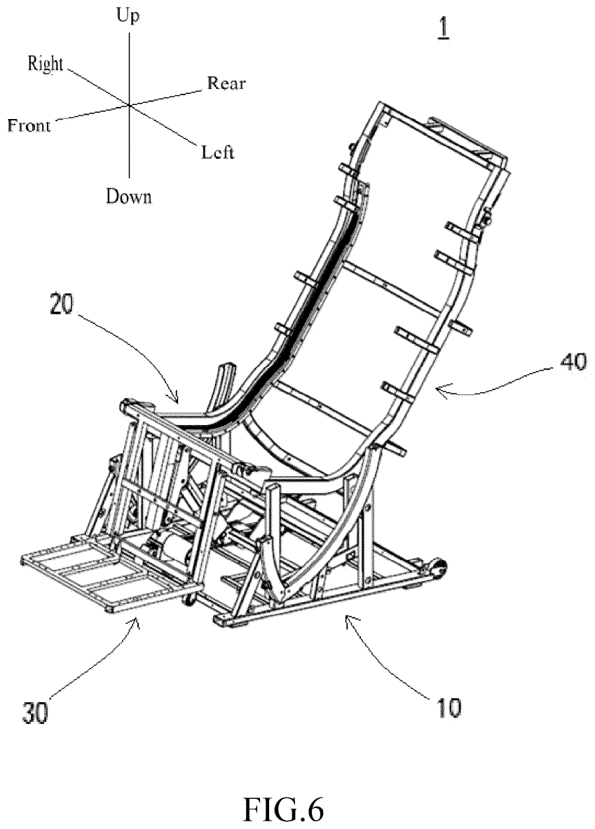

Specifically, as shown in FIGS. 2 and 3, the seating unit 20 includes a seating bottom 21, a seating top 22 and a seating connection portion 23. The seating top 22 is located above the seating bottom 21. The seating connection portion 23 connects the seating bottom 21 and the seating top 22 as a whole. The seating connection portion 23 is provided with a mating portion 24, and the mating portion 24 is movably engaged with the guide rail 12 so that the seating unit 20 does not fall off the guide rail 12 while sliding along the guide rail 12. More specifically, as shown in FIGS. 2 and 3, the seating bottom 21 includes a pair of bottom side bars 211 and a pair of bottom linkages 212. The pair of bottom side bars 211 extend in a plane perpendicular to the left-right direction and are spaced apart in the left-right direction. The pair of bottom linkages 212 extend in the left-right direction, spaced apart in the front-rear direction, and connect the pair of bottom side bars 211. The seating top 22 includes top side bars 221 and top linkages 222. The top side bars 221 extend in a plane perpendicular to the left-right direction, and a pair of top side bars are spaced apart in the left-right direction. The top linkages 222 extend in the left-right direction and connects the pair of top side bars 221. The seating connection portion 23 includes a pair of first linkages 231 and a pair of second linkages 232. The pair of first linkages 231 are spaced apart in the left-right direction and each connect the vicinity of a front end of the bottom side bar 211 to the vicinity of a front end of the top side bar 221. The pair of second linkages 232 are spaced apart in the left-right direction and connect the vicinity of a rear end of the bottom side bar 211 to the vicinity of a rear end of the top side bar 221 (in the illustrated example, the second linkage 232 is shorter in length than the first linkage 231, and when the bottom side bar 211 is in a position in which the length direction coincides with the front-rear direction, an upper end of the second linkage 232 is lower than an upper end of the first linkage 231). A first mating portion 241 is provided adjacent a lower end of each of the pair of first linkages 231. A second mating portion 242 is provided halfway along the length direction of each of the pair of second linkages 232. The first mating portion 241 and the second mating portion 242 are each a pair of rollers in the illustrated example, but are not limited to this. More rollers may also be provided, or a slider may be provided instead of the roller. The distance between the center of the first mating portion 241 (which is the center of rotation of the roller in the illustrated example) and the axis of the first rotating shaft S1 that enables the leg support 30 to be rotatably supported on the seating unit 20 is equal to the distance between the center of the second mating portion 242 and the axis of the first rotating shaft S1. The distance between the center of the first mating portion 241 and the center of the second mating portion 242 is equal to the radius of the first guide rail 121 (the distance between the center of the first guide rail 121 and the middle of a radial width of the first guide rail 121). In FIGS. 6 to 10, the relative positional relationship of the first and second mating portions to the guide rail in different modes, which should otherwise be covered by the guide rail, is illustrated. Of course, the guide rail may also be formed as a hollow shape, in which case the first and second mating portions may be exposed from the guide rail.

In addition, as shown in FIGS. 1 and 2, the seating drive device 50 includes a seating drive push rod 51 and a seating drive slider 52. The seating drive push rod 51 is rotatably connected to the base 10. The seating drive slider 52 is movable in an extension direction of the seating drive push rod 51 and is rotatably connected to the seating unit 20. Specifically, the seating drive push rod 51 extends in a plane perpendicular to the left-right direction, and the front end is rotatably connected to the bottom 11 of the base 10. That is, the front end of the seating drive push rod 51 is fixedly connected to the front end of the base 10, and the seating drive push rod 51 may be rotated in the vertical direction relative to the connection with the base 10. The seating drive slider 52 is rotatably connected to the seating bottom 21 of the seating unit 20. For example, when the seating drive push rod 51 extends or retracts so as to push the seating drive slider 52 to change a position in the extension direction of the seating drive push rod 51, the seating drive slider 52 is rotated by articulation with the seating bottom 21, and the seating bottom 21 is moved accordingly.

### (Leg Support and Drive Structure Thereof)

As shown in FIG. 1, the leg support 30 is a support frame for supporting the lower limbs of the subject.

Here, although not illustrated, a leg cover covering the leg support 30 is usually provided in practice (the portion in contact with the calf of the subject when in use, is for example, made of leather material, fabric, etc.).

In addition, as shown in FIGS. 1 and 2, the leg support 30 includes a footrest 31, a connecting portion 32, and a partition portion 33. The footrest 31 is provided for the feet of the subject, and is generally in the shape of a rectangular plate. In the standby mode, a thickness direction of the footrest 31 is approximately the same as the vertical direction, and a length direction of the footrest 31 is the same as the left-right direction. The connecting portion 32 connects a rear end of the footrest 31 with a front end of the seating unit 20 via the first rotating shaft S1. The partition portion 33 extends forward and upward from the footrest 31 and the connecting portion 32, and three partition portions are arranged at intervals in the left-right direction. Adjacent partition portions 33 form a space for receiving the leg of the subject.

In addition, as shown in FIG. 3, the leg support drive device 60 is located in the vertical direction between the upper surface of the seating unit 20 (the top side bar 221) and the seating bottom 21.

In addition, as shown in FIG. 3, the leg support drive device 60 includes a leg drive push rod 61 and a leg drive linkage 62. The leg drive push rod 61 has a first portion 611 and a second portion 612 capable of extending or retracting relative to the first portion 611. The first portion 611 is rotatably connected to the seating bottom 21 of the seating unit 20. In the illustrated example, a lower end of the leg drive push rod 61 (located in the first portion 611) is hingedly fixed to the seating unit 20, specifically the forward side of the bottom linkage 212, and can rotate about a circumferential direction of the forward bottom linkage 212. The upper end of the leg drive push rod 61 (located in the second portion 612) is capable of extending or retracting with respect to its rear end, and is pivotally connected to the middle of the leg drive linkage 62 in a rotatable manner. The upper end of the leg drive linkage 62 is connected to the front end of the seating unit 20, and can be rotated in the front-rear direction relative to the connection with the seating unit 20. Moreover, a roller is provided at the front end of the leg drive linkage 62. The roller of the leg drive linkage 62 are in sliding contact with the leg support 30 in a manner that supports the leg support 30.

In addition, when the leg support drive device 60 drives the second portion 612 of the leg drive push rod 61 to extend or retract relative to the first portion 611 thereof, the extension or retraction of the second portion 612 will drive the leg drive linkage 62 to move synchronously by articulating with the middle of the leg drive linkage 62. Further, the upper end of the leg drive linkage 62 is rotatably hinged to the front side of the seating top 22 of the seating unit 20, so that the roller disposed at the front end of the leg drive linkage 62 changes in position in the front-rear direction as well as in the vertical direction while the leg drive linkage 62 rotates relative to the front side of the seating unit 20. The change in the position of the roller in the front-rear direction and in the vertical direction causes the leg support 30 supported by the roller to follow its movement. Thus, the leg support 30 is rotated relative to the seating unit 20, and the first rotating shaft S1 is the center of rotation, changing a leg included angle formed by the upper surface of the leg support 30 and the upper surface of the seating unit 20.

### (Backrest and Drive Structure Thereof)

As shown in FIG. 1, the backrest 40 is a support frame for supporting the back of the subject.

Here, although not illustrated, a backrest cover covering the backrest 40 is usually provided in practice (the portion in contact with the back of the subject when in use, is for example, made of leather material, fabric, etc.).

In addition, although not illustrated, an armrest mechanism is provided between the backrest 40 and the seating unit 20. When the backrest 40 reclines rearward or is raised forward relative to the seating unit 20, the portion of the armrest mechanism that holds the arm of the subject is moved rearward or forward in a linked manner.

In addition, as shown in FIGS. 1 and 3, the backrest drive device 70 is located in the vertical direction between the upper surface of the seating unit 20 (the top side bar 221) and the seating bottom 21.

In addition, the backrest drive device 70 includes a backrest drive push rod. The backrest drive push rod has a first portion and a second portion capable of extending or retracting relative to the first portion. The first portion is rotatably connected to one of the seating unit 20 and the backrest 40. The second portion is rotatably connected to the other of the seating unit 20 and the backrest 40. For example, the lower end of the backrest drive push rod (located in the first portion) is hinged to the seating unit 20, specifically to the rear side of the bottom linkage 212. The upper end of the backrest drive push rod (located in the second portion) is hinged to the backrest 40.

In addition, both the leg support drive device 60 and the backrest drive device 70 have one end fixedly connected to the seating unit 20 and rotatable relative to the connection with the seating unit 20, and the other end is telescopic. The extension or retraction of the leg support drive device 60 may drive the leg support 30 to rotate relative to the hinge connection with the seating unit 20, changing a leg included angle formed by a front surface of the leg support 30 and the upper surface of the seating unit 20. The extension or retraction of the backrest drive device 70 may drive the backrest 40 to rotate relative to the hinge connection with the seating unit 20, changing a backrest included angle formed by a front surface of the backrest 40 and the upper surface of the seating unit 20.

### (Massage Mode)

By controlling the seating drive device 50, for example by telescoping the seating drive device 50, so that the massage machine frame 1 can form a standby mode, a zero gravity mode and an assisted-standing mode, and can switch between these states. This enables the subject to receive massages in different postures or body orientations, and facilitates the subject to stand up after the massage.

Here, as shown in FIG. 1, in the standby mode, the first mating portion 241 is located at the connecting portion of the first guide rail 121 and the second guide rail 122 (in the illustrated example, the bottom end of the guide rail 12). Also, the front end of the upper surface of the seating unit 20 (in the illustrated example, which is flush with the upper surface of the top side bar 221 as described below, and in the case of providing the seating cover, which corresponds to the portion in contact with the buttocks and thighs of the subject when the seating cover is in use) is slightly higher than the rear end. However, it may also be set such that in the standby mode, the upper surface of the seating unit 20 is level with the supporting surface (ground).

In addition, the zero gravity mode is a position that allows the torso and legs of the subject to be placed at an angle of about 128±8 degrees. When the subject is in the zero gravity mode, the heart and knee are approximately at the same level, or the subject's feet are higher than the heart. This helps to promote blood circulation and reduce the burden on the heart. At the same time, the body weight of the subject is evenly distributed, without excessive load bearing at a certain point or at some points of the body, thus minimizing the stress on the muscles and bones.

Here, as shown in FIG. 4, in the zero gravity mode, the first mating portion 241 slides on the first guide rail 121, and the second mating portion 242 slides on the second guide rail 122. Also, the front end of the upper surface of the seating unit 20 is much higher than the rear end.

In order to place the massage machine frame 1 in the zero gravity mode, the leg support 30 can be driven to rotate via the leg support drive device 60 such that a leg included angle formed by the upper surface of the seating unit 20 with respect to the front surface of the leg support 30 is any angle within a prescribed range. It is possible to drive the rotation of the seating unit 20 via the seating drive device 50 such that a seating included angle formed by the front surface of the seating unit 20 and the bottom surface of the base 10 is a predetermined prescribed angle, and then drive the rotation of the backrest 40 via the backrest drive device 70 such that a backrest included angle is an angle within a prescribed range. It is also possible, after the backrest included angle is adjusted to a predetermined angle, to drive the seating drive slider 52 to bring the seating unit 20 to increase or decrease the seating included angle as the guide rail 12 slides, and then to adjust the height of the front end of the seating unit 20 such that the front end of the seating unit 20 is higher, equal to or lower than a specific position of the backrest 40. In the zero gravity mode, the specific position of the backrest 40 is the position of the backrest 40 corresponding to the heart of the subject. The position of the subject's heart can be detected or presumed by a conventional body type detection method.

While the massage machine frame 1 remains in the zero gravity mode and the subject is in a zero gravity posture, it is also possible to perform a rocking motion by driving the seating unit 20 to rotate repeatedly around the guide rail 12. That is, while the leg included angle and the backrest included angle each are kept at an included angle required to approach the zero gravity mode, the seating drive slider 52 is driven to reciprocate along the seating drive push rod 51 such that while the body of the subject is kept in the zero gravity posture, the position of the center of gravity of the subject is repeatedly changed such that the joy and feeling of rocking is increased while the subject maintains the zero gravity posture.

In addition, the assisted-standing mode is a state that facilitates the subject to stand up from the massage machine frame 1.

Here, as shown in FIG. 5, in the assisted-standing mode, the first mating portion 241 and the second mating portion 242 are on the second guide rail 122, and the second mating portion 242 is located to a maximum extent away from the first guide rail 121. Also, the front end of the upper surface of the seating unit 20 is slightly lower than the rear end. For example, the seating included angle formed by the upper surface of the seating unit 20 with respect to the horizontal plane (the bottom surface of the base) may be formed as an included angle of 5°-40°. Of course, the seating included angle can be appropriately designed. For example, the seating included angle in the assisted-standing mode can be preset to a prescribed angle such as 5°, 10°, 15°, 20°, 25°, 30°, etc., and you can also fine-tune the seating included angle to the desired angle of the subject through the subject's control. Also, the backrest 40 is positioned upright relative to the seating unit 20, such as the backrest included angle being approximately 90°.

When it is desired to place the massage machine frame 1 in the assisted-standing mode, the seating drive slider 52 can be driven to move along the seating drive push rod 51. For example, the leg included angle is less than 270° but greater than 180°.

According to the massage machine frame 1 of the present implementation, the first guide rail 121 is in the shape of a circular arc which projects forward, and thus, by moving the first mating portion 241 on the first guide rail 121, the seating unit 20 is easily caused to recline substantially rearward, forming the zero gravity mode; also, the second guide rail 122 is in the shape of a circular arc which projects rearward and has a different center than the first guide rail 121, and thus, by switching the first mating portion 241 to move on the second guide rail 122, the rear end of the seating unit 20 is easily raised substantially, thereby forming the assisted-standing mode to facilitate the subject's standing up; moreover, by forming the first guide rail 121 and the second guide rail 122 into a circular arc, in contrast to the case where the first guide rail 121 and the second guide rail 122 extend in a straight line, the overall machine frame may be more compact in the front-rear direction. With this compact structure, the seating drive device 50 requires only a small stroke of telescopic movement to enable the front and rear ends of the seating unit 20 to have a large mutual positional relationship change in the vertical direction.

The present disclosure has been exemplarily described above in conjunction with the accompanying drawings, and obviously, the specific implementation of the present disclosure is not limited to the above implementations.

For example, in the above implementation, in the assisted-standing mode, it is also possible to drive the leg support 30 and the backrest 40, respectively, in a state suitable for the subject to stand up. For example, the leg included angle is less than 270° but greater than 180°, such that the backrest included angle β ranges from 80° to 110°. The above adjustment steps may be in no order. You can also adjust the seating included angle and the leg included angle before adjusting the backrest included angle, which can further help the subject to stand up by providing the subject with a rear-to-front thrust through the backrest.

Furthermore, in the above implementation, the base 10 has a guide rail 12 and the seating unit 20 has a mating portion 24 which is movably snapped to the guide rail 12, but it is not limited thereto. It is also possible that the seating unit 20 has a guide rail 12 and the base 10 has a mating portion 24 that is movably snapped to the guide rail 12.

Furthermore, in the above implementation, the first guide rail 121 has a radius smaller than that of the second guide rail 122, but it is not limited thereto. The radius of the first guide rail 121 may also be equal to the radius of the second guide rail 122, or may be greater than the radius of the second guide rail 122.

Furthermore, in the above implementation, the distance between the center of the first mating portion 241 and the axis of the first rotating shaft S1 is equal to the distance between the center of the second mating portion 242 and the axis of the first rotating shaft S1. But it is not limited to this, the distance between the center of the first mating portion 241 and the axis of the first rotating shaft S1 may be greater than the distance between the center of the second mating portion 242 and the axis of the first rotating shaft S1, or may be less than the distance between the center of the second mating portion 242 and the axis of the first rotating shaft S1.

Furthermore, in the above implementation, the distance between the center of the first mating portion 241 and the center of the second mating portion 242 is equal to the radius of the first guide rail 121, but it is not limited thereto. The distance between the center of the first mating portion 241 and the center of the second mating portion 242 may also be larger than the radius of the first guide rail 121, or may be smaller than the radius of the first guide rail 121.

Furthermore, in the above implementation, the specific structures of the base 10, the leg support 30, the backrest 40, the seating drive device 50, the leg support drive device 60 and the backrest drive device 70 may be appropriately modified as required.

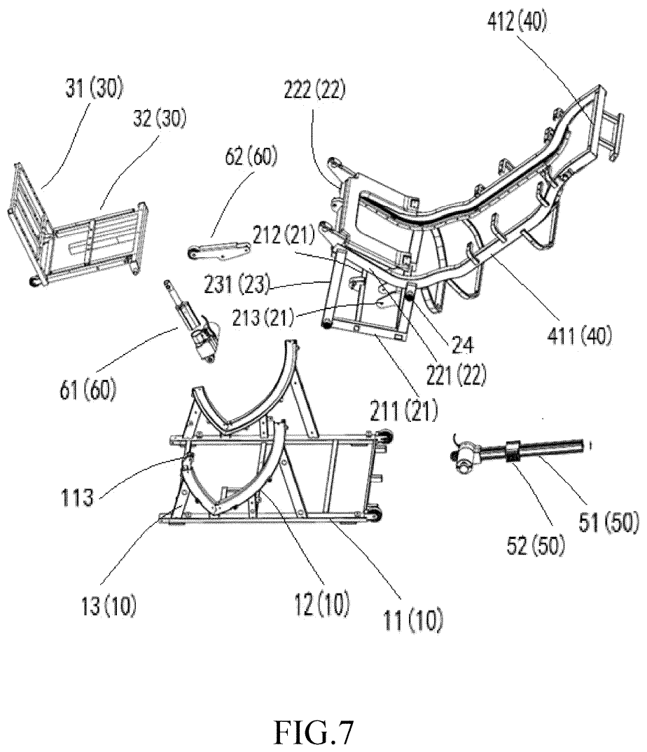

Furthermore, in the above implementation, the backrest 40 is rotatably supported to the seating unit 20 via the second rotating shaft, but it is not limited thereto. As shown in FIGS. 6 and 7, the backrest 40 may also be fixed to the seating unit 20 (i.e., the backrest 40 is not rotatable relative to the seating unit 20) and formed integrally with the seating unit 20 to form an integrated seat frame. At this point, the backrest drive device 70 may be omitted.

Specifically, in the variant shown in FIGS. 6 and 7, a portion of the seating top 22 of the seating unit 20 is formed integrally with a portion of the backrest 40. More specifically, the backrest 40 includes a backrest side bar 411 and a backrest linkage 412. The backrest side bar 411 extends in a plane perpendicular to the left-right direction, and a pair of backrest side bars are provided spaced apart in the left-right direction. The front end of the backrest side bar 411 is integrally formed with the rear end of the top side bar 221 of the seating unit 20. The backrest linkage 412 extends in the left-right direction and connects upper ends of the pair of backrest side bars 411. Thus, the seating unit 20 and the backrest 40 form an integrated seat frame.

The seating drive push rod 51 of the seating drive device 50 is rotatably connected to a first lug 113 of the base 10. The seating drive slider 52 is movable in the extension direction of the seating drive push rod 51 and is rotatably connected to a second lug 213 provided to the seating unit 20 of the seat frame. The leg drive push rod 61 of the leg support drive device 60 has a first portion and a second portion capable of extending or retracting relative to the first portion. The first portion is rotatably connected to the seat frame (in the illustrated example, the bottom linkage 212 of the seating bottom 21 of the seating unit 20). The second portion is rotatably connected to the leg drive linkage 62 midway. The upper end of the leg drive linkage 62 is rotatably connected to the front end of the seating unit 20 (in the example shown, the top linkage 222).

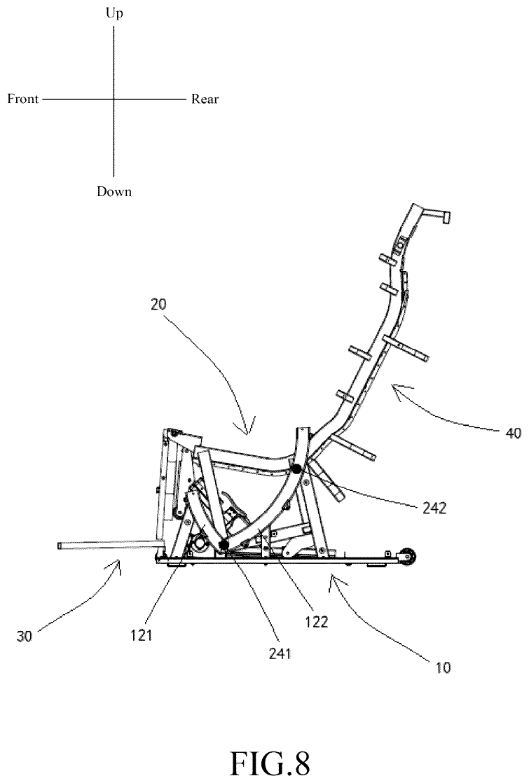

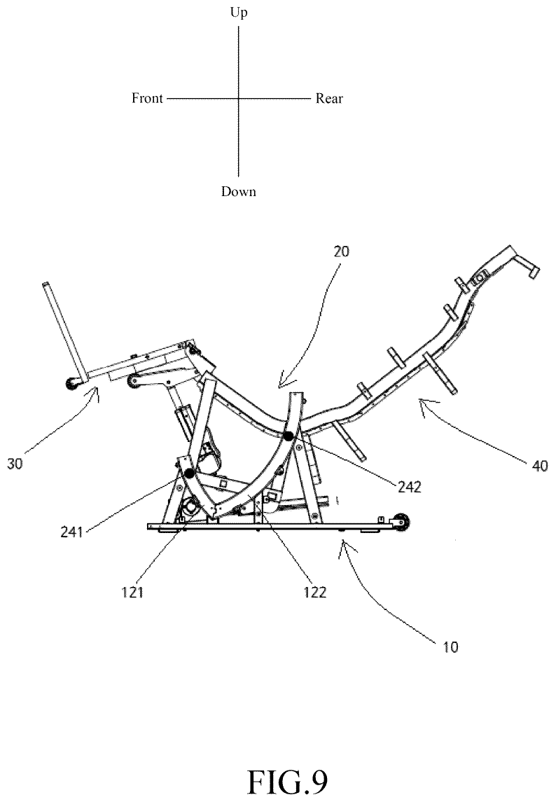

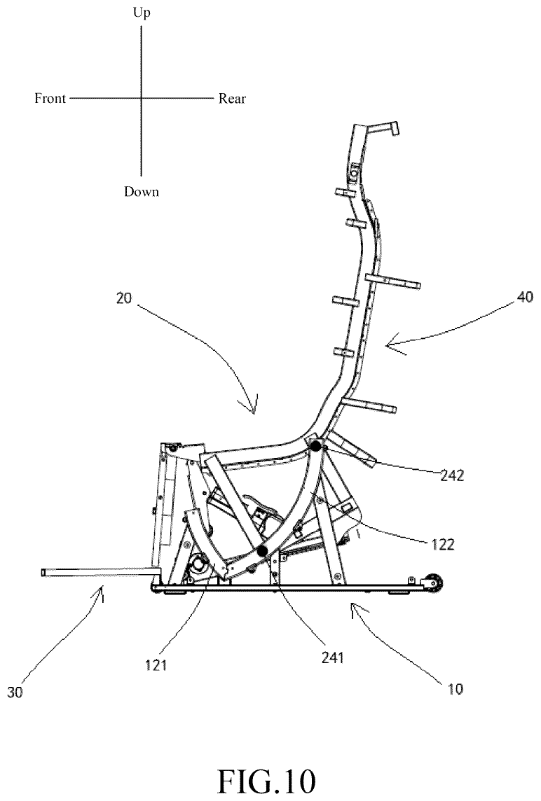

Thereby, the seating drive device 50 drives the seating unit of the seat frame to move along the guide rail, causing the seating unit and the backrest to simultaneously change its positional relationship with the base, so that the massage machine frame 1 forms the standby mode (see FIG. 8), the zero gravity mode (see FIG. 9) and the assisted-standing mode (see FIG. 10), etc. as described above, and this enables the massage machine frame 1 to switch between these states. That is, in the case where the above-described structure is adopted, various modes such as assisted standing, reclining, zero gravity, and compression can be realized by a single drive device, thereby contributing to reduced production costs.

It will be appreciated that within the scope of the present disclosure, various parts of the embodiments can be freely combined, or various parts of the embodiments can be appropriately modified or omitted.

What is claimed is:

1. A massage machine frame, comprising a base and a seating unit which is supported to the base in such a way that the seating unit is movable relative to the base,
wherein one of the base and the seating unit has a guide rail and the other has a mating portion cooperating with the guide rail,
the guide rail including:
a first guide rail in the shape of a circular arc projecting forward; and
a second guide rail in the shape of a circular arc projecting rearward and having a different center of circle than the first guide rail, and
the mating portion including:
a first mating portion switchable from moving on the first guide rail to moving on the second guide rail; and
a second mating portion which moves on the second guide rail.

2. The massage machine frame according to claim 1, wherein a lower end of the first guide rail and a lower end of the second guide rail are connected to each other.

3. The massage machine frame according to claim 1, wherein the first guide rail has a radius smaller than that of the second guide rail.

4. The massage machine frame according to claim 1, further comprising a leg support which is rotatably supported to the seating unit via a rotating shaft,
wherein a distance between a center of the first mating portion and an axis of the rotating shaft is equal to a distance between a center of the second mating portion and an axis of the rotating shaft.

5. The massage machine frame according to claim 1, wherein a distance between a center of the first mating portion and a center of the second mating portion is equal to a radius of the first guide rail.

6. The massage machine frame according to claim 1, wherein an upper end of the first guide rail is lower than an upper end of the second guide rail.

7. The massage machine frame according to claim 1, wherein the first mating portion and the second mating portion are rollers.

8. The massage machine frame according to claim 1, further comprising a backrest,
wherein the backrest is rotatably connected to the seating unit, or alternatively, the backrest and the seating unit are fixedly formed as a whole.

9. The massage machine frame according to claim 1, further comprising a seating drive device,
wherein the seating drive device includes:
a seating drive push rod rotatably connected to one of the base and the seating unit; and
a seating drive slider movable along the seating drive push rod and rotatably connected to the other of the base and the seating unit.

10. A massage machine, comprising a massage machine frame according to claim 1.

11. A control method of a massage machine for controlling the massage machine according to claim 10, wherein the massage machine performs at least one of a zero gravity mode and an assisted-standing mode;
in the zero gravity mode, the first mating portion slides on the first guide rail, and the second mating portion slides on the second guide rail; and
in the assisted-standing mode, the first mating portion and the second mating portion are located on the second guide rail, and the second mating portion is located, to a maximum extent, away from the first guide rail.
